(19) United States
(12) Patent Application Publication
(10) Pub. No.: US 2021/0291005 A1
(43) Pub. Date: Sep. 23, 2021

(54) PHYSICAL THERAPY DEVICE AND METHOD FOR STRETCHING MUSCLES IN THE FOOT

(71) Applicant: Solestretch, LLC, Wadsworth, OH (US)

(72) Inventor: William J. Flickinger, Wadsworth, OH (US)

(21) Appl. No.: 17/226,909

(22) Filed: Apr. 9, 2021

Related U.S. Application Data
(63) Continuation-in-part of application No. 16/667,622, filed on Oct. 29, 2019.

(51) Int. Cl. A63B 21/00; A63B 23/035; A63B 23/10; A63B 23/08

(52) U.S. Cl. CPC A63B 21/00185; A63B 21/0004; A63B 21/4034; A63B 23/08; A63B 23/03508; A63B 23/10; A63B 21/4035

(57) ABSTRACT

A physical therapy device to stretch the plantar fascia, muscles of the feet and lower leg. The physical therapy device has an elongated shaft that has a brace affixed to a first end of the shaft and a sinusoidal-shaped handle affixed to the second end of the shaft. When the sinusoidal-shaped handle element is pulled toward the human user, the brace engages the foot such that the intended stretch on the plantar and posterior portions of the foot and leg is initiated.

### CROSS-REFERENCE TO RELATED APPLICATIONS

This application is a continuation-in-part application f co-pending U.S. patent application Ser. No. 16/667,622 filed Oct. 29, 2019 entitled “Physical Therapy Device and Method for Stretching Muscles in the Foot,” the technical disclosure of which is hereby incorporated by reference in its entirety.

### BACKGROUND

### Technical Field

The present disclosure relates to physical therapy. More particularly, and not by way of limitation, the present disclosure is directed to an apparatus and method for stretching the plantar fascia and tendons and muscles located in the foot and on the back of the leg.

### Description of Related Art

The plantar fascia is located on the bottom of the foot or the plantar side. Plantar fasciitis is inflammation of the fascia and causes pain. It can be aggravated when walking, running or standing and the pain can be debilitating. Stretching of the fascia and tendons and muscles on the dorsal side or back the leg can reduce this pain. However, active stretching, such as when the person is standing and stretching using a slant board or other device can cause the targeted muscles to contract, putting undue tension on the tendons, which can result in micro tears, which cause further pain. Elastic or inelastic bands and even towels are often recommended but are cumbersome to use. The angle of stretch is difficult to control. They are often looped around the arch of the foot and this does not stretch the plantar fascia. Stretching by contracting the antagonistic muscles of the anterior leg can cause cramping and tightening of those muscles and in extreme cases, shin splints. It would be advantageous to have an apparatus and method for engaging the foot distal to the metatarsi that enables a full stretch of the plantar fascia, muscles of the feet and lower leg that overcomes the disadvantages of the prior art. The present disclosure provides such a system and method.

### BRIEF SUMMARY

The present disclosure is directed to an elongated shaft that is held approximately parallel to the long axis of the leg, at least a brace that is attached to the elongated shaft that is oriented such that it is held perpendicular to the long axis of the leg. The brace is oriented essentially perpendicular to the long axis of the leg such that when engaged with the foot the foot is in the neutral position. The brace is configured to be long enough to engage the width of the foot. The elongated shaft may include a sinusoidal-shaped handle attached to the end opposite from the brace element. The elongated shaft may be adjustable to fit the user, with the grip easily gripped between the knee and hip.

The brace and the handle element may include a hinge that enables these elements to fold essentially parallel to the elongated shaft for storage and transport. Grips on the elongated shaft or the brace element and sinusoidal-shaped handle allow for the placement of the foot and hands to reduce the chance of slippage. The grips may conform to the toes and the fingers of the hand to improve grip. The material of the elongated shaft, brace, and/or sinusoidal-shaped handle may be metal, such as steel or aluminum, carbon fiber, wood, or plastic. The sinusoidal-shaped handle may be rubber, plastic, leather, or other material that offers cushioning and a high coefficient of friction to reduce slipping. The brace may include a conical element that can be used to manipulate pressure points.

### BRIEF DESCRIPTION OF THE DRAWINGS

The novel features believed characteristic of the disclosure are set forth in the appended claims. The disclosure itself, however, as well as a preferred mode of use, further objectives and advantages thereof, will be best understood by reference to the following detailed description of illustrative embodiments when read in conjunction with the accompanying drawings, wherein:

FIG. 1 is a depiction of one embodiment of the present invention, specifically illustrating the location of the handle element and the brace element.

FIG. 2 is an alternate embodiment of the present invention, specifically illustrating a different type of handle that can be affixed to the invention.

FIG. 3 is a telescoped view of the adjustment mechanism as found in an alternate embodiment of the present invention.

FIG. 4 is a telescoped view of the hinge mechanism as found in an alternate embodiment of the present invention.

FIG. 5 is an alternate embodiment of the present invention, specifically illustrating a combination of perpendicular arms for both the brace element and the handle element.

FIG. 6 is an alternate embodiment of the present invention, specifically illustrating the adjustment mechanism.

FIG. 7 is an alternate embodiment of the present invention, specifically illustrating the location of the conical element on the brace element of the present invention.

FIG. 8 is a perspective view of another embodiment of the present invention depicting the placement of the device in relation to the planter surface of the foot of the user.

FIG. 9 is a perspective view of another embodiment of the present invention depicting the placement of the device in relation to the foot of the user from the medial side of the right foot of the user, the direction of pull and the resultant direction of stretch of the foot around the axis of the ankle.

FIG. 10 is a perspective view of an embodiment of a physical therapy device.

FIG. 11 is an illustration of an embodiment of a detachable physical therapy device.

FIG. 12 is a bottom view of an embodiment of a physical therapy device engaged with a foot.

FIG. 13 is a side view of an embodiment of a physical therapy device engaged with a foot.

### DETAILED DESCRIPTION

The present invention is directed to a physical therapy device and method of treatment of the plantar surface of the foot and the posterior muscles and tendons of the leg. The physical therapy device includes a handle and an elongated shaft that extends from approximately mid-thigh to beyond the bottom of the foot, where the shaft bends such that a brace element is formed that is essentially positioned perpendicular to the shaft. The brace element is configured with a non-slip surface to grip the toes.

In one embodiment, a handle is at the top of the elongated shaft by grip along its axis. In yet another embodiment, the shaft may include a handle that is perpendicular to the elongated shaft. In another embodiment, the handle may be hinged to fold such that it is parallel to the elongated shaft for storage. In yet another embodiment, the handle is fashioned such that the center of the handle is more or less centered to the first shaft. In any of the embodiments, the brace element engaging the foot may also be hinged such that it can be folded so that it is parallel to the elongated shaft for storage.

In any of the embodiments, the elongated shaft may be adjustable along its length to accommodate a variety of leg lengths. Furthermore, the elongated shaft can be constructed from a wide variety of materials including, but limited to, any type of metal, wood, polymer, or carbon fiber. This disclosure also describes a method of unweighted stretching of the tendons, fascia and muscles of the plantar surface of the foot and the posterior of the leg. The unweighted nature of the stretch reduces the chances of incidental macro and micro tears of the tendons of the ankle and around the heel from muscle activation in response to postural demands. It reduces the foreshortening of the anterior leg muscles when these are used to dorsiflex the foot to stretch the targeted structures. These and other features of the disclosure are described in the paragraphs below.

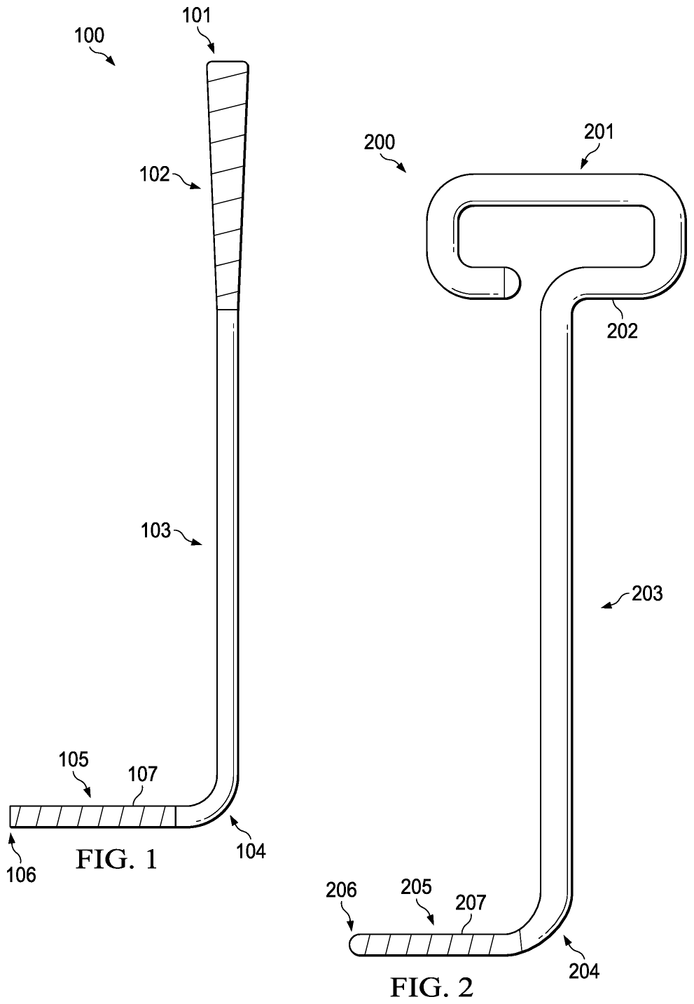

FIG. 1 depicts an exemplary embodiment of the present invention 100 from a side view. The elongated shaft 103 is oriented such that it is placed parallel with a human leg. As stated above, the elongated shaft can be constructed from a wide variety of materials including, but limited to, any type of metal, wood, polymer, or carbon fiber. The elongated shaft 103 does not have to be entirely ridged and can be semi-ridged. When the elongated shaft 103 is placed parallel with the human leg, it is oriented so that the first end 101 is placed pointed away from the body of the human. On the opposite end of the elongated shaft 103 is the second end 104. The handle element 102 is attached to the elongated shaft 103 and it can to a wide variety of forms, as well as be constructed from various materials that are known to one of ordinary skill in the art. Generally, the elongated shaft 103 can be between 24 and 60 inches in length. However, it can be longer or shorter, depending on the needs of the human user.

In FIG. 1, the handle element 102 is depicted as a polymer material that is cut into a long strip and then wraps around the second end 101 of the elongated shaft 103. The wrapping is done is a spiral like manner, moving uniformly along the elongated shaft 103 until the material covers the second end 101. As the material wraps along the elongated shaft, one edge of the material is covered by the material and the other edge covers material so that an overlapping effect is produced. Alternate embodiments may possess different types of handles. For instance, the entire handle element 102 may be constructed of a solid or pieced together rubber unit that is very similar to a golf club handle.

A brace element 105 is affixed to the second end 104 of the elongated shaft 103. As depicted in FIG. 1, the brace element 105 is an arm that is oriented so that it is perpendicular to the elongated shaft 103. Generally, the bracing element is between 2 and 12 inches long, but it can be longer or shorter, depending on the needs of the human user. In addition, FIG. 1 depicts the bracing element 105 to be covered in a grip surface 107 which is a surface or grip that engages the toes to prevent slippage. The grip surface 107 can be a wide variety of materials or substances. For instance, it can be an abrasive material similar to sandpaper or sticky substance. As depicted in FIG. 1, the grip surface 107 is a polymer wrap which is constructed and arranged similar to the handle element 102 described above. The brace element 105 also possesses a distal end 106 that is located on the opposite end from where the brace element 105 is affixed to the elongated shaft 103.

FIG. 2 depicts an alternate embodiment of the present invention 200 from a side view. The elongated shaft 203 is has a first end 201 and a second end 204. In this embodiment, the handle element 202 is designed as a looped handle and affixed to the elongated shaft 203 at the first end 201. The brace element 205 is this embodiment is also affixed to the elongated shaft 203 at the second end 204. Furthermore, the brace element 205 is oriented to be perpendicular to the elongated shaft 203. Similar to FIG. 1, the brace element 205 has a grip surface 207 that is designed to prevent slippage and covers the distal end 206 of the brace element 205.

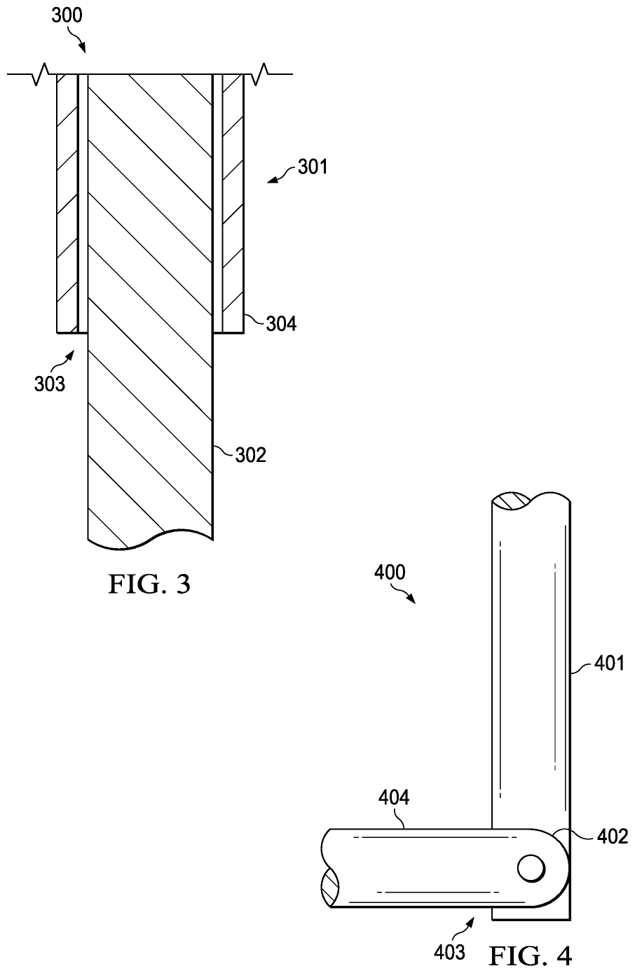

FIG. 3 depicts a close-up view of the present invention 300 in which a telescoping mechanism 303 is depicted. The elongated shaft 301 has two parts. The first part is the outer casing 304, and the second part is the inner casing 302. The inner casing 302 possesses a smaller diameter than the outer casing 304 such that the inner casing 302 can slide in and out of the outer casing 304. A locking mechanism is utilized to lock the inner casing 302 so that it can be fixed in place with regards to the outer casing 304. The locking mechanism can be any number of telescoping tubing locks that are known by one of ordinary skill in the art.

FIG. 4 depicts a close-up view of the present invention 400 in which a hinge 402 is depicted. As illustrated in previous figures, the brace element 404 is displayed affixed at the first end 403 of the elongated shaft 401 and oriented such that it is perpendicular to the elongated shaft 401. The hinge 402 resists the brace element 404 from being oriented at an angle greater than 90 degrees in relation to the elongated shaft 401. However, the hinge 402 allows for the brace element 404 to be folded so that it is parallel to the elongated shaft 401. The hinge 402 allows for the invention to be more easily stored.

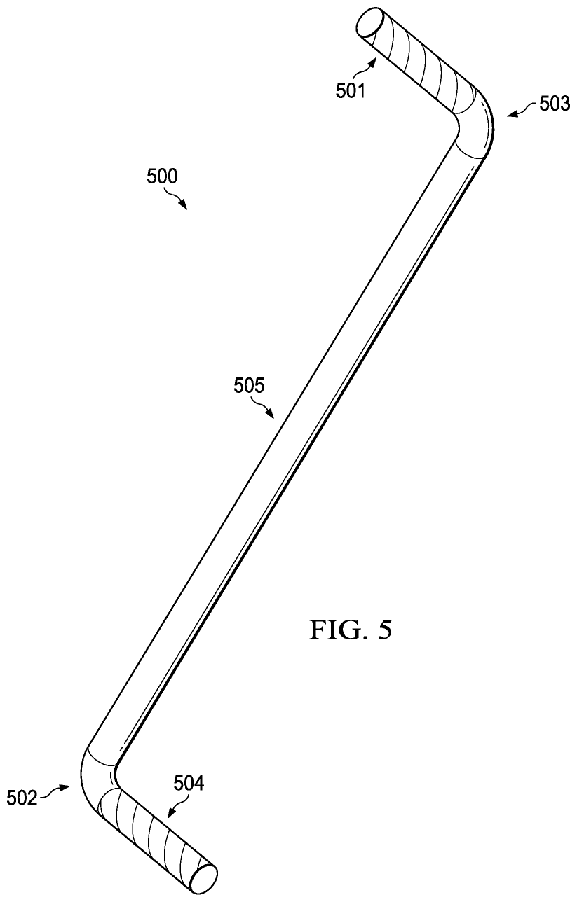

FIG. 5 depicts an alternate embodiment of the present invention 500 from an angled view. In the present embodiment, the elongated shaft 505 has a handle element 501 affixed at the second end 503 and the brace element 504 affixed at the first end 502. Both the handle element 501 and the brace element 504 are displayed as being oriented perpendicular to the elongated shaft 505. The handle element 501 and the brace element 504 are displayed as being perpendicular to each other.

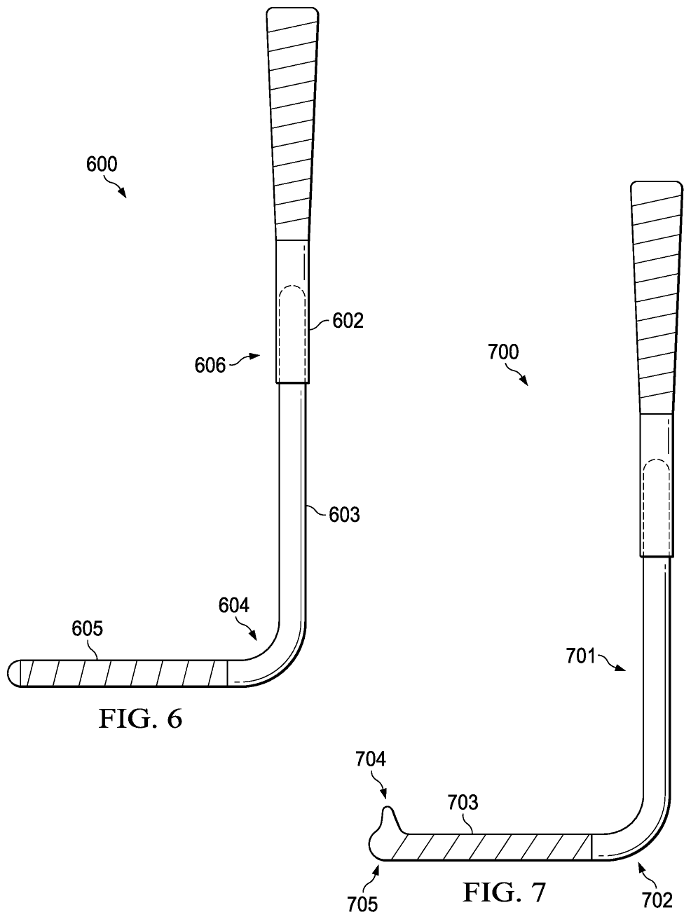

FIG. 6 depicts an alternate embodiment of present invention 600 with a side view, specifically illustrating the telescoping mechanism that allows for the length of the elongated shaft 606 to be adjusted. The elongated shaft is connected to the handle element 601 as displayed and contains two parts. The first part is the outer casing 602, and the second part is the inner casing 603. The inner casing 603 possesses a smaller diameter than the outer casing 602 such that the inner casing 603 can slide in and out of the outer casing 602. A locking mechanism is utilized to lock the inner casing 603 so that it can be fixed in place with regards to the outer casing 602. The locking mechanism can be any number of telescoping tubing locks that are known by one of ordinary skill in the art. Also, the brace element 605 is connected to the inner casing 603 at the first end 604.

In FIG. 7, an alternate embodiment is displayed that is the same as depicted in FIG. 6 except for the addition of the conical element 704. The elongated shaft 701 is connected at the first end 702 to the brace element 703. In addition, the conical element 704 is affixed at the distal end 705 of the brace element 703. The conical element 704 is a small cone that protrudes out of the brace element 703 and is intended to be used by the human user to manipulate soft tissue and target pressure points, areas of cramping, or scar tissue.

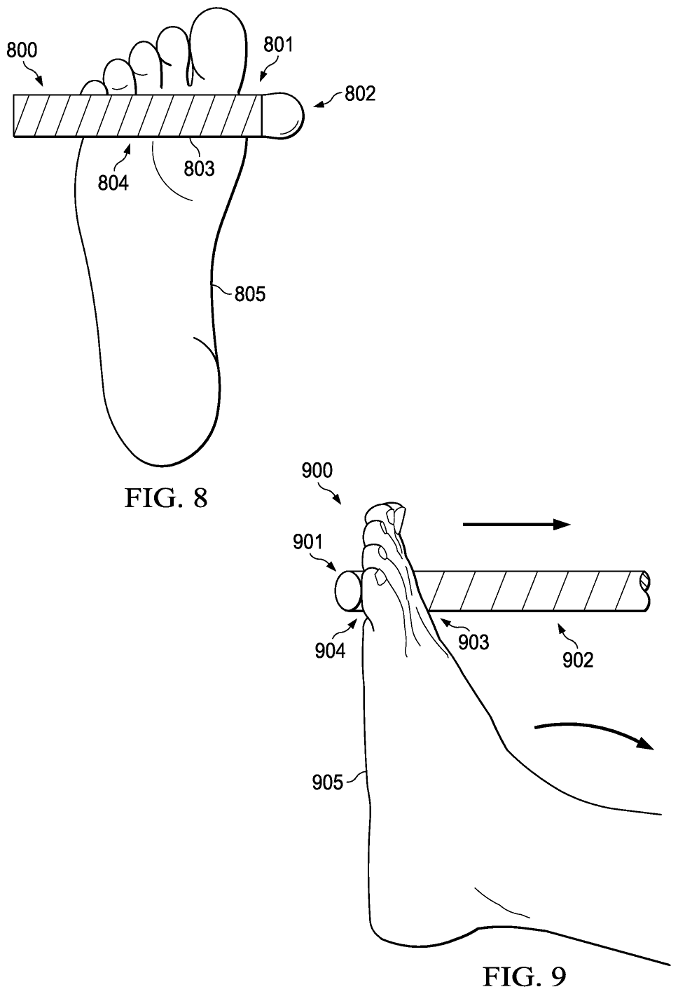

FIG. 8 depicts an environmental view of the present invention 800 with the foot bottom 805 facing outward. The brace element 801 is placed under the digital sulcus 804 of the foot bottom 805. When pressure is applied to the digital sulcus 804 of the foot bottom 805, a stretch of the plantar and posterior portions of the foot and leg, including the Achilles tendon, triceps surae, the hamstring, and the intrinsic musculature of the foot and plantar fascia is initiated. The grip surface 803 is affixed to the brace element 801 to keep the foot bottom 805 from slipping. The foot bottom 805 is depicted centrally located along the brace element 801, away from the distal end 802 of the brace element 801.

FIG. 9 depicts an environmental view of the present invention 900 from the side. In addition, the direction of that the foot 905 is pulled which is toward the body is displayed. The elongated shaft 902 is affixed to the brace element 901 which, in turn, is centered at the digital sulcus 904 of the foot 905. The human user pulls on the invention such that the brace element engages the foot 905 and bends the toes 903 of the human, thereby initiating the intended stretch on the plantar and posterior portions of the foot and leg.

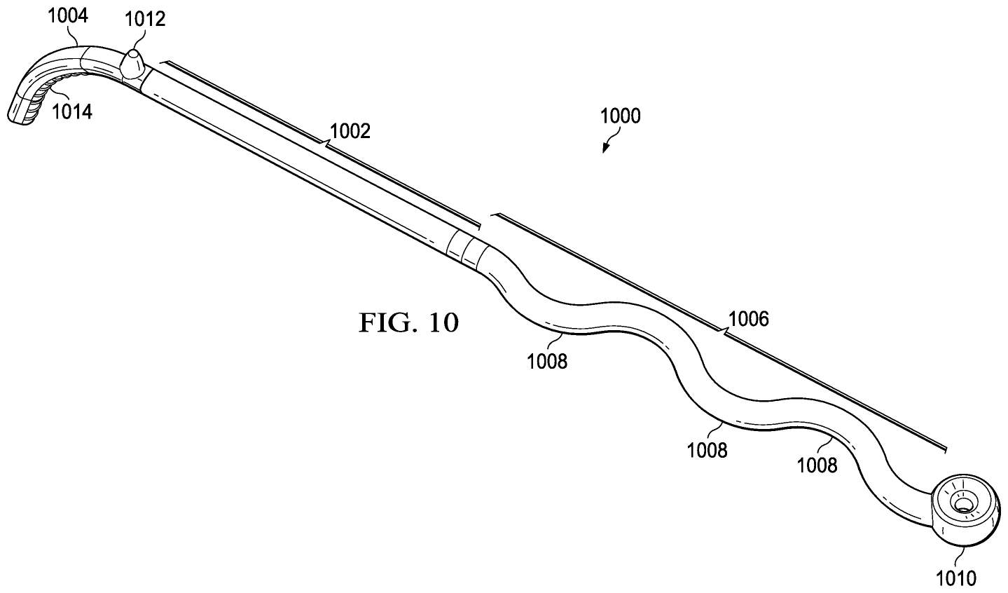

With reference to FIG. 10, an embodiment of a physical therapy device 1000 for a user is shown. The physical therapy device 1000 comprises an elongated shaft 1002 having a first end and a second end. Generally, the elongated shaft 1002 is between 8 inches and 40 inches. However, the length of the elongated shaft 1002 may be longer or shorter depending on the needs of the user. A brace 1004 may be coupled to the first end of the elongated shaft 1002 such that the brace 1004 extends substantially perpendicularly (e.g., between 45 degrees and 135 degrees) from the elongated shaft 1002. The brace 1004 is configured to engage with the foot of the user. The brace 1004 may include a plurality of ridges 1014 along the length of the brace 1004. The plurality of ridges 1014 provide slip resistance that helps prevent the foot from slipping off the brace 1004 as pressure from the brace 1004 is applied to the foot. Additionally, the plurality of ridges 1014 can be used to apply pressure to the foot or leg of the user, which enables the user to massage the muscles of the foot or leg. Generally, the brace 1004 is between 2 inches and 12 inches long, but the brace 1004 may be longer or shorter, depending on the needs of the user.

The physical therapy device 1000 may further include a sinusoidal-shaped handle 1006 coupled to the second end of the elongated shaft 1002. Generally, the sinusoidal-shaped handle 1006 is between 8 inches and 50 inches. However, the length of the sinusoidal-shaped handle 1006 may be long or shorter, depending on the needs of the user. The sinusoidal-shaped handle 1006 includes a plurality of handgrip locations 1008, which allow users of various sizes to comfortably grasp the physical therapy device 1000. In one embodiment that sinusoidal-shaped handle 1006 includes four handgrip locations. For example, a smaller user may choose to grasp a handgrip location 1008 closest to the elongated shaft 1002 because they have shorter arms and legs. Alternatively, users with longer arms and legs may choose to grasp a handgrip location 1008 further away from the elongated shaft 1002. The advantage of the plurality of handgrip locations 1008 on the sinusoidal-shaped handle 1006 is that users have various options to comfortably grasp the physical therapy device 1000 to apply the proper amount of force on their foot. The sinusoidal-shaped handle 1006 may also include a grip attached to the surface. The grip may comprise a high-friction material such as a rubber or plastic to allow for easier gripping, or a low-friction material to facilitate the massage functions described below. Additionally, the grip may include a plurality of ridges. The advantage of including the grip on the surface of the sinusoidal-shaped handle 1006 is that the user may better maintain their grasp on the handgrip locations 1008.

The sinusoidal-shaped handle 1006 may be shaped to enable the user to massage parts of the body, such as the arm, neck, upper or lower leg. The sinusoidal-shaped handle 1006 may also be used to anchor a stretch band away from the leg by placing one loop of the handle on the thigh above the knee such that it is essentially perpendicular to the axis of the leg. The user then loops one end of a stretch band around a far loop of the sinusoidal-shaped handle 1006 and then loops the other end of a stretch band around their foot. In one instance, the sinusoidal-shaped handle 1006 is extended laterally away from the leg, and the user then rotates the foot medially away from the handle to effect a tensioning of the stretch band.

In another embodiment, a deep tissue element 1010 may be coupled to the end of the sinusoidal-shaped handle 1006 furthest away from the elongated shaft 1002. The deep tissue element 1010 may include a disk-shaped attachment or a ball-shaped attachment. The deep tissue element 1010 is configured to engage the leg or foot muscles of the user. For example, the user may grasp the handgrip locations 1008 and press the deep tissue element against an area of the leg or foot that needs relief. The configuration of the sinusoidal-shaped handle 1006 enables the user to apply various amounts of pressure on the leg or foot.

In another embodiment, the brace 1004 may include a deep tissue nub 1012. The deep tissue nub 1012 may configured to extend outwardly from a location along the length of the brace. For example, the deep tissue nub 1012 may located near the first end of the elongated shaft 1002. The deep tissue nub 1012 may have various shapes such as, but not limited to, conical, cylindrical, triangular, or spherical. The deep tissue nub 1012 is configured to engage the leg or foot muscles of the user. The advantage of using the deep tissue nub 1012 is that it may engage areas of the user's leg or foot that may not adequately be reached by the deep tissue element 1010, or the deep tissue nub 1012 may be able to apply a more appropriate amount of pressure to a given area of the user's foot or leg.

In another embodiment, the sinusoidal handle is omitted and the elongated shaft 1002 is attached to a different type of handle on the side opposite the brace 1004. For example, the handle can comprise the axial grip shown in FIG. 1, the loop shown in FIG. 2, or other shape that ensures a secure grip.

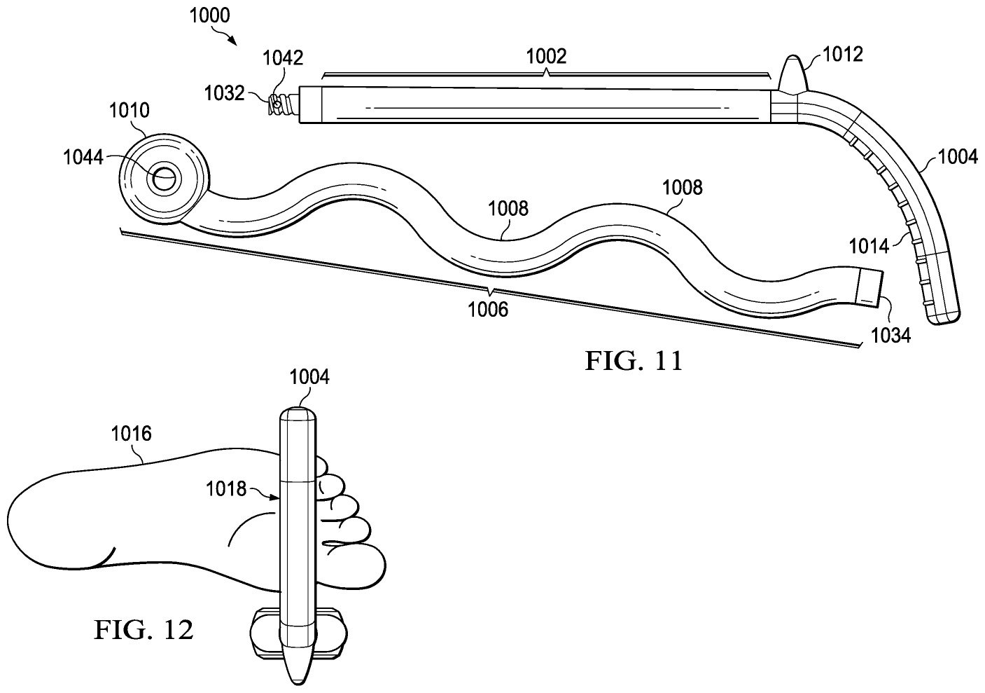

Referring to FIG. 11, the physical therapy device 1000 may be a single piece or it may be comprised of one or more detachable elements. The brace 1004 may be removably coupled to the first end of the elongated shaft 1002, or the brace may extend from or be permanently affixed to the first end of the elongated shaft 1002. Similarly, the sinusoidal-shaped handle 1006 may be removably coupled to the second end of the elongated shaft 1002. The brace 1004 or the sinusoidal-shaped handle 1006 may be removably coupled to the elongated shaft 1002 by having a male threaded end 1032 on second end of the elongated shaft 1002 that is screwed into a correspondingly threaded female end 1034 of the sinusoidal-shaped handle 1006, or the male/female connection may be reversed. Alternatively, the brace 1004 and the sinusoidal-shaped handle 1006 may have a smaller diameter than the elongated shaft 1002, and engage with one another through a press fit. Additionally, the brace 1004 and the sinusoidal-shaped handle 1006 may have spring-loaded pins extending outwardly, and the elongated shaft 1002 may have receiving holes for the spring-loaded pins. The spring-loaded pins of the brace 1004 and the sinusoidal-shaped handle 1006 may be depressed as the brace and the sinusoidal-shaped handle 1006 are slid into the elongated shaft 1002 and spring out upon engaging with the holes of the elongated shaft 1002. Alternatively, the brace 1004 and the sinusoidal-shaped handle 1006 may be removably coupled to the elongated shaft using combinations of the above-referenced arrangement or other arrangements.

In a preferred embodiment, the male threaded end 1032 of the elongated shaft 1002 comprises a hole 1042 extending through the diameter of the male threaded end 1032. In this embodiment, both pieces of the device can be attached to one another by passing an attachment mechanism through hole 1042 and hole 1044 in deep tissue element 1010.

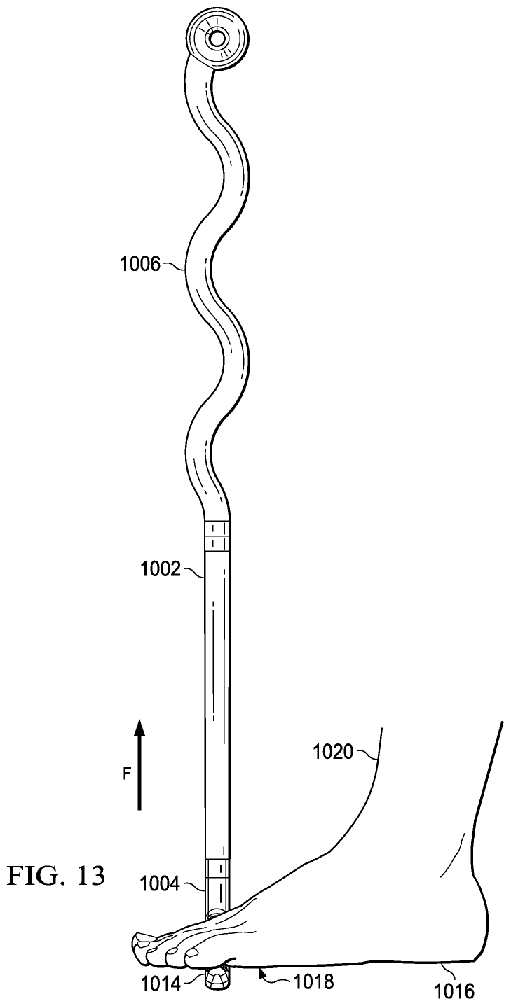

Referring to FIGS. 12 and 13, a method for stretching the muscles of the leg and foot of a user with a physical therapy device 1000 is shown. The elongated shaft 1002 is placed substantially parallel with the leg 1020 of the user where the first endo of the elongated shaft 1002 is distally located to the user and the second end is proximally located to the user. The brace 1004 is placed under the digital sulcus 1018 of the user's foot bottom 1016. Pressure is applied to the digital sulcus 1018 by pulling the sinusoidal-shaped handle toward the user, which stretches the plantar and posterior portion of the foot and leg, including the toes, intrinsic muscles of the foot, plantar fascia, Achilles tendon, triceps surae, or the hamstring. The plurality of ridges 1014 on the brace 1004 prevent the user's foot bottom 1016 from slipping off the brace 1004.

While this disclosure has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that certain technology is prior art to any embodiment(s) in this disclosure. Neither is the “Brief Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

1. A physical therapy device for a user comprising:
an elongated shaft having a first end and a second end;
a brace extending from the first end of the elongated shaft such that the brace extends substantially perpendicularly from the elongated shaft, wherein the brace is configured to engage a foot of the user; and
a sinusoidal-shaped handle coupled to the second end of the elongated shaft, wherein the sinusoidal-shaped handle includes a plurality of handgrip locations.

2. The physical therapy device of claim 1, wherein the sinusoidal-shaped handle is removably coupled to the second end of the elongated shaft

3. The physical therapy device of claim 1, wherein the brace is removably coupled to the first end of the elongated shaft.

4. The physical therapy device of claim 1, wherein the sinusoidal-shaped handle consists of four handgrip locations, wherein further the sinusoidal-shaped handle is configured to be pulled toward a torso of the user when a foot of the user is engaged with the brace.

5. The physical therapy device of claim 4, the sinusoidal-shaped handle comprising a grip attached to a surface of the sinusoidal-shaped handle.

6. The physical therapy device of claim 1, further comprising a disk-shaped massage attachment coupled to an end of the sinusoidal-shaped handle opposite the elongated shaft.

7. The physical therapy device of claim 1, further comprising a ball-shaped massage attachment coupled to an end of the sinusoidal-shaped handle opposite the elongated shaft.

8. The physical therapy device of claim 1, wherein the brace comprises a nub extending in a radial direction from the brace.

9. The physical therapy device of claim 1 further comprising ridges along a length of the brace.

10. A physical therapy device for a user comprising:
an elongated shaft having a first end and a second end;
a brace extending from the first end of the elongated shaft such that the brace extends substantially perpendicularly from the elongated shaft, the brace comprising a nub extending outwardly, wherein the brace is configured to engage a foot of the user; and
a sinusoidal-shaped handle removably coupled to the second end of the elongated shaft, wherein the sinusoidal-shaped handle includes a plurality of handgrip locations.

11. The physical therapy device of claim 10, wherein the sinusoidal-shaped handle consists of four handgrip locations.

12. The physical therapy device of claim 11, the sinusoidal-shaped handle comprising a grip attached to a surface of the sinusoidal-shaped handle.

13. The physical therapy device of claim 10, further comprising a disk-shaped massage attachment coupled to an end of the sinusoidal-shaped handle opposite the elongated shaft.

14. The physical therapy device of claim 10, further comprising a ball-shaped massage attachment coupled to an end of the sinusoidal-shaped handle opposite the elongated shaft.

15. The physical therapy device of claim 10 further comprising ridges along a length of the brace.

16. The physical therapy device of claim 10 further comprising a male threaded connector at the second end of the elongated shaft and a hole in the male threaded connector extending throughout a diameter of the male threaded connector.

17. A method for stretching the muscles of a leg and foot of a user with a physical therapy device, the physical therapy device comprising: an elongated shaft having a first end and a second end; a brace coupled perpendicularly to the first end of the elongated shaft; and a sinusoidal-shaped handle coupled to the second end of the elongated shaft, the method comprising:
placing the elongated shaft parallel with the leg, wherein the elongated shaft is oriented such that the first end is distally located to the user, and the second end is proximally located to the user;
engaging the foot with the brace, wherein the brace is configured to engage a digital sulcus portion of the foot; and
pulling the sinusoidal-shaped handle toward the user, wherein muscles in the leg and foot are continually stretched.

18. The method of claim 17, wherein the brace is further configured to engage toes on the foot to stretch a plantar portion of the foot and a posterior portion of the foot including one or more toes, intrinsic muscles of the foot, a plantar fascia, an Achilles tendon, triceps surae, and a hamstring.

19. A method for strengthening muscles of a leg of a user with a physical therapy device, the physical therapy device comprising a sinusoidal-shaped shaft, the method comprising:
placing the sinusoidal-shaped shaft perpendicular to the leg, wherein the shaft extends laterally away from the central axis of the body, looping one end of a stretch band around the shaft, looping the other end of the stretch band around a foot of the user, and, holding the shaft in place, rotating the foot of the user inward to effect tension on the stretch band, the resistance of which strengthen the muscles of the posterior leg, including the posterior tibialis.
